(19) United States
(12) Patent Application Publication
(10) Pub. No.: US 2026/0192964 A1
(43) Pub. Date: Jul. 9, 2026

(54) A system configured to print and apply labels

(71) Applicant: Videojet Technologies Inc., Wood Dale, IL (US)

(72) Inventor: Steven John Buckby, Wood Dale, IL (US)

(21) Appl. No.: 19/135,685

(22) PCT Filed: Dec. 6, 2023
(86) PCT No.: PCT/GB2023/053144

§ 371 Date: Jun. 4, 2025

(30) Foreign Application Priority Data
Dec. 6, 2022 (GB) 2218334.7

(51) Int. Cl. B65C 9/40; B65C 1/02; B65C 9/00; B65C 9/46

(52) U.S. Cl. CPC B65C 9/40; B65C 1/02; B65C 9/46; B65C 2009/0053; B65C 2009/404

(57) ABSTRACT

A system (1) configured to print and apply labels (PL, LL) to articles comprising, a label printer (186) configured to print an image on a label in a printing orientation, a label dispenser (2) configured to dispense the printed label, a label applicator (3) configured to apply the dispensed label to an article in an application orientation, and a controller (50) configured to determine the printing orientation and the application orientation in dependence upon an indication of image quality associated with a label.

### FIELD

The present disclosure relates to a system for applying labels to articles, and more particularly a system for printing, dispensing and applying labels to articles such as those that have been stacked on pallets, and methods of operating the same.

### BACKGROUND

Articles are frequently stacked on pallets for shipping. Such articles are typically secured to each other and/or onto the pallet by stretch wrap, strapping or other securing means. The word ‘pallet’ is used herein to refer to a completed pallet ready to ship typically comprising; a wooden (or plastic) pallet, stacked articles and (optionally) securing means. An empty pallet may be referred to as a ‘pallet base’.

Labels are applied to ready-to-ship pallets to enable information associated with the contents of the pallet, or the destination to which the pallet should be shipped (amongst other things) to be provided on the pallet in a readily accessible format. This enables the label and the information stored on the label to be read at various points after the label has been applied. For example, the information might be read when a pallet is loaded onto a distribution vehicle, when it is transferred to a further distribution vehicle, or when it reaches a final destination. The information contained within the label may be read multiple times during the transport of pallet. In order to provide convenient and efficient reading of the information contained in the label, a standard format may be used. Industry standards exist to provide guidance as to the format and information contained on such labels, with one such industry standard being the GS1 logistic label guidelines. Industry standards labelling formats allow the transport of goods using multiple transport modes including, road, rail, air and maritime to operate using a common label format.

Some of the information may be encoded on a label in text format, whereas other information may be encoded on the label in barcode format. The barcode format may allow identity information to be encoded in a machine readable way. It will be understood that multiple barcodes may exist in a label. For example, in a GS1 label format a first barcode may comprise information related to the contents of a pallet. A second barcode may contain a unique identification number which comprises information which is unique to a particular pallet. That is, no two pallets will have barcodes of the second type that are the same, such that every single pallet labelled according to the GS1 standard may be uniquely identified.

For information encoded within a barcode to be successfully read, it is necessary for the barcode to be accurately printed, and for the label to be accurately applied to the pallet. Moreover, given the nature of a barcode, a single missing vertical line can result in a barcode becoming unreadable. Perhaps more dangerously, a single missing line of printing within a barcode can result in the barcode encoding different information to that which is intended. It will of course be appreciated that either of those outcomes is undesirable. It is important, therefore, within a label print and applying apparatus, to provide robust quality control measures, and also to provide a high degree of confidence that a label applied to a product accurately reflects the information that is intended to be contained within the label.

Pallets to be labelled may take a variety of forms. Ideally pallets will be stacked with uniform boxes to a standard permitted height, with all sides vertically aligned. Boxes are typically secured onto the pallet base by stretch wrap, strapping or other securing means. In such an arrangement a label can be placed at standard location (e.g. between 400 mm and 800 mm from the floor, and at least 50 mm from a corner). However, not all pallets conform to such standard dimensions. For example, a pallet may be incomplete, and so may be too low to accommodate a label in the standard location. Alternatively, a side surface of a pallet may not be suitable to accommodate a label (e.g. it may be sloped, or irregular). As such, while conventional pallet label applicators may be configured to apply labels to standard pallets, these may fail to properly apply labels to non-standard pallets, either failing to adequately label a pallet, or signalling for human intervention to apply a label manually.

Conventional label applicators conventionally use compressed air to “blow” labels onto the label applicator. This can reduce the risk that labels will not be properly aligned or gripped by the label applicator.

Conventional label applicators use manipulators to advance a label towards a labelling target (e.g. a pallet). Such manipulators may be pneumatic, hydraulic, or motor driven, and are typically arranged to move an applicator head (or pad) along a primary axis (i.e. toward and away from a pallet) to apply a label to a front face of a pallet. In some cases, an applicator head may be further able to rotate about a vertically aligned axis to allow labelling on a side face of a pallet.

The present disclosure is concerned with improvements to label applicators. It is an object of the present disclosure, among others, to provide a system for labelling that addresses one or more problems associated with known label applicators, whether identified herein or otherwise.

According to a first aspect of the present disclosure there is provided a system configured to print and apply labels to articles. The system comprises a controller configured to determine data indicative of image quality of an image associated with a label, a label printer configured to print an image on a label in a printing orientation, a label dispenser configured to dispense the printed label, and a label applicator configured to apply the dispensed label to an article in an application orientation. The printing orientation and the application orientation are dependent upon the data indicative of image quality.

According to a second aspect of the present disclosure there is provided a system configured to print and apply labels to articles. The system comprises a label printer configured to print an image on a label in a printing orientation, a label dispenser configured to dispense the printed label, a label applicator configured to apply the dispensed label to an article in an application orientation, and a controller configured to determine the printing orientation and the application orientation in dependence upon an indication of image quality associated with a label.

Determining the printing orientation may comprise selecting between a first printing orientation and a second printing orientation. Determining the application orientation may comprise selecting between a first application orientation and a second application orientation.

The controller of the first or second aspect may be configured to determine the printing orientation and the application orientation such that an image component within the image has a predetermined orientation when applied to the article.

It is possible to overcome certain issues associated with poor print quality by rotating label images prior to printing. A versatile label applicator and label applicator pad allow labels to be rotated prior to application to compensate for an image rotation which may have been introduced during the printing process of the label. In this way, a measure of printed label quality can be increased, and production interruptions due to label print quality issues reduced. Thus, by causing the printing orientation and application orientation to be dependent upon an indication of image quality (e.g. data indicative of image quality) it is possible to mitigate or compensate for identified or predicted image defects.

According to a third aspect of the present disclosure there is provided a system configured to print and apply labels to articles. The system comprises a label printer configured to print an image comprising an image component on a label in a printing orientation, the printing orientation being selected from a first printing orientation and second printing orientation, a label dispenser configured to dispense the printed label, a label applicator configured to apply the dispensed label to an article in an application orientation, the application orientation being selected from a first application orientation and a second application orientation, and a controller configured to determine the printing orientation and the application orientation such that the image component has a predetermined orientation when applied to the article.

By ensuring that the image component (e.g. a barcode) has the predetermined orientation, difficulties associated with reading the image by a scanner (e.g. a barcode scanner) can be reduced. For example, a barcode can be aligned in an expected (e.g. horizontal) orientation after application regardless of whether the label has a portrait or landscape orientation. This also allows greater flexibility for the printer and applicator, since image defects associated with a particular printing orientation can be minimised.

The following features may be applied to any of the first, second or third aspects described above.

The image, or an image component within the image, may have a predetermined orientation when applied to the article irrespective of the application orientation.

The controller may be configured to determine the printing orientation and the application orientation in dependence upon an indication of image quality associated with a label.

The controller may be configured to determine the data indicative of image quality based upon the indication of image quality.

The controller may be configured to determine data indicative of image quality associated with the label, and determine the printing orientation and the application orientation in dependence upon the data indicative of image quality.

The application orientation refers to an orientation of the label when applied to the article.

Determining the printing orientation may comprise selecting between a first printing orientation and a second printing orientation. Determining the application orientation may comprise selecting between a first application orientation and a second application orientation.

The label applicator may be capable of adjusting the orientation of the label relative to the article by rotating the label about a label orientation axis. The label orientation axis may be normal to the plane of the label. The label applicator may be further capable of applying the label to the article in the application orientation.

The system may comprise a single apparatus, or a collection of cooperating component parts.

The system may further comprise a label applicator pad configured to receive and support a dispensed label. The label applicator may be connected to the label applicator pad.

The label applicator pad may be configured to receive a dispensed label in a dispensed orientation.

The label applicator may be configured to manipulate the label applicator pad relative to an article to be labelled so as to apply the label to the article in the application orientation. Adjusting the orientation of the label relative to the article may comprise rotating the label. Adjusting the orientation of the label relative to the article may comprise maintaining the label in the dispensed orientation.

The label applicator may be operable to rotate the label applicator pad relative to the article so as to apply the label in a first application orientation or a second application orientation.

The controller may be configured to determine the application orientation and the printing orientation based on data indicative of image quality.

By determining the printing orientation based on data indicative of image quality, the likelihood of a defective image being printed can be reduced. Once printed, the label can be applied in the determined application orientation. In this way, any image rotation applied prior to printing can be compensated for during application. For example, a 90 degree clockwise rotation may be applied to images prior to printing on the label, and a 90 degree anticlockwise rotation may be applied to the printed label prior to application, so as to ensure that the applied label (and, importantly, the image printed upon the label) is in a desired orientation on the article.

The application orientation may be based on the printing orientation, which may, in turn, be based on the indication of print quality, or data indicative of print quality.

Printing in the determined printing orientation may be performed before or after the determination of application orientation has been made.

In some cases an initial printing step may be performed in a first (i.e. non-printing) orientation. A label printed in the initial printing step may then be discarded (e.g. if a determination is made that the image quality is insufficient) before a further label is printed in the second printing orientation.

The system may be capable of adjusting the orientation of the image to be printed on the label. The system may be capable of adjusting the orientation of an image component of the image to be printed on the label.

The controller may be configured to adjust the image and to provide printing instructions to the printer to print the image in the printing orientation. Adjusting the image may comprise rotating one or more image components and/or rearranging one or more image components.

The controller may be configured to receive an indication of image quality from at least one of: an image sensor, a barcode scanner, a barcode verifier, a controller associated with the printer, the indication of image quality comprising data indicative of an expected image quality, and a user input.

The user input may comprise an indication that printed image quality is insufficient (either based on visual inspection by a user, or a signal received by a user (e.g. from a barcode scanner or verifier).

In such a configuration, a user may select an alternative operation mode (e.g. a rotated label mode) via a user interface associated with the controller of the system. Alternatively a user may simply indicate that image quality is insufficient (e.g. by selecting a “poor quality” option). Upon the receipt of the indication, the controller may select an appropriate printing orientation and application orientation.

When the printing orientation is a first printing orientation, the application orientation may be a first application orientation. When the printing orientation is a second printing orientation, the application orientation may be a second application orientation. That is, each printing orientation may have a corresponding application orientation.

For example, if the determined printing orientation is the first printing orientation, the determined application orientation may be the first application orientation. Conversely, if the determined printing orientation is the second printing orientation, the determined application orientation may be the second application orientation.

In an example embodiment, the first application orientation may be a portrait orientation and the second application orientation may be a landscape orientation. It will be understood that a given label having a rectangular shape could be applied in either orientation. However, if a label was printed with the intention of being applied in one orientation, but it was subsequently applied in another orientation, readability of the printed content may be impaired (e.g. if a barcode was included, and was oriented incorrectly as a result of the wrong choice of application orientation).

The controller may be configured to determine the application orientation and the printing orientation based on the determined data indicative of image quality. The controller may be further configured to cause the printer to print the label in the printing orientation. The controller may be further configured to cause the label applicator to apply the label in the determined application orientation.

The controller may be further configured to control or more of the label printer, the label dispenser, the label applicator and the label applicator pad.

The image printed on the label may comprise a barcode. The barcode may comprise the image component. The data indicative of image quality may comprise data indicative of barcode quality. The indication of image quality may comprise an indication of barcode quality.

The data indicative of barcode quality may comprise an indication of barcode readability. The data indicative of barcode quality may comprise a determination of whether or not a barcode can be read. The data indicative of barcode quality may comprise a binary indication (i.e. “pass” or “fail”).

The barcode may comprise a plurality of bars, the bars being aligned with a label dispensing direction when the printing orientation is the first printing orientation.

The label dispensing direction may refer to a direction in which the labels are dispensed by a label dispenser. For example, the label may move in the label dispensing direction away from a peel beak of the label dispenser.

The dispensed orientation may be the orientation in which the label is provided once it has been dispensed, by moving in the dispensing direction.

The bars may be orthogonal to the label dispensing direction when the printing orientation is the second printing orientation.

The application direction may be the dispensed orientation or a rotated orientation. The rotated orientation may be rotated with respect to the dispensed orientation. The rotated orientation may be rotated by around 90 degrees with respect to the dispensed orientation.

The application orientation may be a first rotated orientation or a second rotated orientation. In some embodiments, the label may be rotated in every case, with a determination being made between a first rotation amount and a second rotation amount.

If print quality (either actual print quality, based on inspection of a printed label, or expected print quality, based on expected printer performance) is sufficient, the printing orientation may be the first (e.g. ‘normal’) printing orientation, with a picket-fence style barcode. In such a situation, the application orientation may be the first (e.g. ‘normal’) application orientation.

Conversely, if print quality is insufficient (or expected to be insufficient), the printing orientation may be the second (e.g. ‘rotated’) printing orientation, with a ladder style barcode. The second printing orientation may be rotated by around 90 degrees with respect to the first printing orientation. In such a situation, the application orientation may be the second (e.g. ‘rotated) application orientation.

Applying the printed label in the determined application orientation may comprise, if the determined orientation is the first application orientation, applying the label in the orientation in which it was received; and if the determined orientation is the second application orientation, rotating (or adjusting) the label after it is received and applying the label in a rotated orientation.

Conversely, if the determined orientation is the first application orientation, the label applicator may be configured to rotate the label after it is received and apply the label in a rotated orientation, and vice versa. That is, a label rotation may be a default situation in some circumstances, depending on the printer and applicator configuration, and on the particular labelling requirements of the articles to be labelled.

The system may further comprise a sensor configured to generate sensor data indicative of a characteristic of an image printed on the label.

The sensor may be associated with the label applicator. The sensor may be mounted to a label applicator pad support. The label applicator pad may be configured to rotate relative to the sensor.

The sensor may be associated with the label applicator pad. The sensor may be provided in the label applicator pad.

The data indicative of image quality may be determined based upon the sensor data.

The data indicative of image quality may comprise data indicative the quality of an image printed on the label. Determining data indicative of image quality may comprise obtaining sensor data indicative of a characteristic of an image printed on the label.

Determining data indicative of image quality may comprise obtaining an image of a printed label, for example using the sensor. The sensor may comprise an image capture device (e.g. a scanner or camera).

The sensor may comprise a scanner. The scanner may comprise a linear sensor array. The linear sensor array may comprise a barcode scanner. The linear sensor array may comprise 1-dimensional array.

The system may be configured to: print a first label in the first printing orientation; generate sensor data indicative of the characteristic of the image printed on the first label; determine data indicative of image quality based on the sensor data; and if the data indicative of image quality meets a predetermined printed criterion: determine that the printing orientation is the first printing orientation and the application orientation is the first application orientation; and apply the printed label in the first application orientation.

The data indicative of image quality may comprise a pass/fail determination. When the data indicative of image quality meets a predetermined printed criterion the image may be considered to “pass”.

If the data indicative of image quality does not meet the predetermined printed criterion, the system may be configured to: discard the first printed label; print a second label in the second printing orientation; determine that the printing orientation is the second printing orientation and the application orientation is the second application orientation; and apply the second printed label in the second application orientation.

When data indicative of image quality does not meet the predetermined printed criterion the image may be considered to “fail”.

The data indicative of image quality may comprise data indicative of an expected image quality. The indication of image quality may comprise data indicative of an expected image quality.

The data indicative of image quality may comprise data indicative the expected quality of an image to be printed on a label.

The data indicative of an expected image quality may be generated based on data indicative of a characteristic of the printer.

Determining data indicative of image quality may comprise obtaining data indicative of a characteristic of the printer. The characteristic of the printer may comprise a printhead characteristic. The printhead characteristic may comprise data indicative of printing element status (e.g. a dead dot map). The data indicative of printing element status may comprise data indicative of a status of each one of a plurality of printing elements within a printhead of the printer.

If the data indicative of an expected image quality meets a predetermined expected criterion, the system may be configured to print a first label in the first printing orientation.

Once a label has been printed in the first printing orientation, it may be applied in the dispensing orientation.

Additionally, once a label has been printed in the first printing orientation (e.g. after a determination that an expected image quality meets the predetermined expected criterion), the printed label may be scanned, and if the (scanned) quality is sufficient (i.e. the data indicative of image quality based on the sensor data meets the predetermined printed image criterion), the label may be applied in the dispensing orientation. Alternatively, if the (scanned) quality is insufficient, the label may be discarded and a second label printed in the second printing orientation before being applied in the second application orientation.

If the data indicative of an expected image quality does not meet the predetermined expected criterion, the system may be configured to print a first label in the second printing orientation.

Once a label has been printed in the second printing orientation, it may be applied in the second application orientation. That is, in response to an expected failure of image quality, the first label may be printed in the second printing orientation, without a label having been first printed in the first printing orientation.

The system may comprise a sensor configured to generate sensor data indicative of a characteristic of a label applied to the article.

The sensor may be the same sensor used to generate sensor data indicative of a characteristic of an image printed on the label. The sensor may be a barcode scanner.

The system may be configured to obtain data indicative of a characteristic of a label applied to the article in either of the first application orientation or the second application orientation.

That is, since the image printed on the label can be rotated before being printed, the image (e.g. barcode) can be read by the scanner (e.g. a barcode scanner) after application regardless of the application orientation, since in either application orientation, the image will have the same orientation. That is, the controller may be a controller configured to determine the printing orientation and the application orientation such that an image component (e.g. the barcode) has a predetermined orientation (e.g. horizontal) when applied to the article.

Where the sensor is configured to rotate with the label applicator pad, if the application orientation is the second application orientation, the controller may be configured to cause the label applicator to rotate the label applicator pad after applying the label and control the sensor to generate sensor data indicative of a characteristic of the label applied to the article after rotating the label applicator pad. If the application orientation is the first application orientation, the controller may be configured to control the sensor to generate sensor data indicative of a characteristic of the label applied to the article with the label applicator pad in the first application orientation.

If the sensor data indicative of a characteristic of a label applied to the article does not meet a predetermined applied criterion, and if the application orientation is the first application orientation, the system may be configured to: print a second printed label in the second printing orientation; determine that the application orientation is the second application orientation; and apply the second printed label in the second application orientation.

The label applicator may be configured to manipulate the label in 2-dimensions relative to articles to be labelled.

The label applicator may comprise a label applicator arm.

The label applicator may be configured to manipulate the label in 3-dimensions relative to articles to be labelled.

The label applicator may comprise: a first actuator configured to move a label towards and away from the article; a second actuator configured to move the label in a direction parallel with the article movement direction; and a third actuator configured to rotate the label applicator pad about a vertical axis.

The first actuator may comprise a linear actuator. The second actuator may comprise a linear actuator. The third actuator may comprise a rotational actuator.

The label applicator may be a robotic arm. The robotic arm may comprise a 6-axis robotic arm.

The system may further comprise a motion controller configured to control a position of the label applicator pad. The motion controller may be configured to receive outputs of a plurality of position sensors, each position sensor being associated with a respective part of the label applicator; and to control a position of the label applicator pad based upon the received outputs.

The motion controller may be configured to cause the label applicator pad to apply a label to an article. The motion controller may be configured to cause the label applicator pad to receive a label from a label dispenser.

The invention further provides a method of operating a system according to the first aspect.

There is also provided a first method of applying labels to articles. The method comprises: determining data indicative of image quality of an image associated with a label; printing an image on a label in a printing orientation; dispensing the printed label; and applying the label to an article in an application orientation. The printing orientation and the application orientation are dependent upon the data indicative of image quality.

There is also provided a second method of applying labels to articles. The second method comprises: determining a printing orientation; printing an image on a label in the printing orientation; dispensing the printed label; determining an application orientation; and applying the label to an article in the application orientation. The printing orientation and the application orientation are determined in dependence upon an indication of image quality associated with a label.

The method may comprise determining data indicative of image quality associated with the label, and determining the printing orientation and the application orientation in dependence upon the data indicative of image quality.

It is possible to overcome certain issues associated with poor print quality by rotating label images prior to printing. A versatile label applicator and label applicator pad allow labels to be rotated prior to application to compensate for an image rotation which may have been introduced during the printing process of the label. In this way, a measure of printed label quality can be increased, and production interruptions due to label print quality issues reduced. Thus, by causing the printing orientation and application orientation to be dependent upon data indicative of image quality it is possible to mitigate or compensate for identified or predicted image defects.

The following features may be applied to either of the first or second methods.

The method may comprise determining the printing orientation and the application orientation such that an image component within the image has a predetermined orientation when applied to the article.

There is also provided a first method of applying labels to articles. The method comprises: determining a printing orientation, the determining comprising selecting the printing orientation from a first printing orientation and second printing orientation; printing an image comprising an image component on a label in the printing orientation; dispensing the printed label; determining an application orientation, the determining comprising selecting from a first application orientation and a second application orientation; and applying the label to an article in the application orientation. The printing orientation and the application orientation are determined such that that the image component has a predetermined orientation when applied to the article.

The following features may be applied to any of the first to third methods.

The image component within the image may have a predetermined orientation when applied to the article irrespective of the application orientation.

The method may further comprise determining data indicative of image quality based upon the indication of image quality.

The application orientation refers to an orientation of the label when applied to the article.

The printing orientation and the application orientation may be determined in dependence upon an indication of image quality associated with a label.

The method may further comprise determining data indicative of image quality associated with the label, and determining the printing orientation and the application orientation in dependence upon the data indicative of image quality.

The determination of data indicative of image quality may be performed before or after printing of the label.

The determination of data indicative of image quality may be performed before and after printing. For example, a first determination may be made before printing based upon expected image quality (e.g. based on expected printer performance) and, if it is decided to proceed with printing based on the first determination, a second determination may be made based upon actual image quality (e.g. by scanning a printed image with a sensor).

A determination of printing orientation may be a default determination. If subsequent processing results in a determination of poor image quality, a new determination of a printing orientation (e.g. a rotated orientation) may be made.

When the printing orientation is a first printing orientation, the application orientation may be a first application orientation. When the printing orientation is a second printing orientation, the application orientation may be a second application orientation.

The method may comprise: printing a first label in the first printing orientation; generating sensor data indicative of the characteristic of an image printed on the first label; determining data indicative of image quality based on the sensor data; and if the data indicative of image quality meets a predetermined printed criterion: determining that the printing orientation is the first printing orientation and the application orientation is the first application orientation; and applying the printed label in the first application orientation.

The method may further comprise, if the data indicative of image quality does not meet the predetermined printed criterion: discarding the first printed label; printing a second label in the second printing orientation; determining that the printing orientation is the second printing orientation and the application orientation is the second application orientation; and applying the second printed label in the second application orientation.

Features described in the context of the systems described above may be applied to the above described methods.

The methods described above can be implemented in any convenient form. As such the invention also provides computer programs which can be executed by a controller of the system so as to cause the system to be controlled in the manner described above. Such computer programs can be stored on computer readable media such as non-tangible, not transitory computer readable media.

### BRIEF DESCRIPTION OF THE DRAWINGS

Embodiments of the present disclosure will now be described, by way of example only, with reference to the accompanying drawings, in which:

FIG. 1 is a side view of a pallet labelling apparatus for applying a label to a pallet;

FIG. 2 is an alternative perspective view of the pallet labelling apparatus of FIG. 1;

FIG. 3 is a schematic view of a labelling machine forming part of the pallet labelling apparatus of FIG. 1;

FIG. 4 is a plan view a label applicator forming part of the pallet labelling apparatus, with the label dispenser omitted;

FIG. 5 is a perspective view of part of the label applicator;

FIGS. 6a and 6b are plan views of part of the label applicator in different configurations;

FIGS. 7a and 7b are perspective views of a label applicator pad;

FIGS. 8a and 8b are front views of a label applicator pad of the label applicator in portrait and landscape configurations, respectively;

FIGS. 9a to 9d are perspective views of the label applicator applying a label to various pallet surfaces;

FIG. 10 is a schematic diagram of control system for a labelling machine which forms part of the pallet labelling apparatus of FIG. 1;

FIG. 11 is a flow chart showing a control process performed by the control system during operations of the pallet labelling apparatus; and

FIGS. 12 and 13 are schematic representations of the portrait and landscape label layouts, respectively.

### DETAILED DESCRIPTION

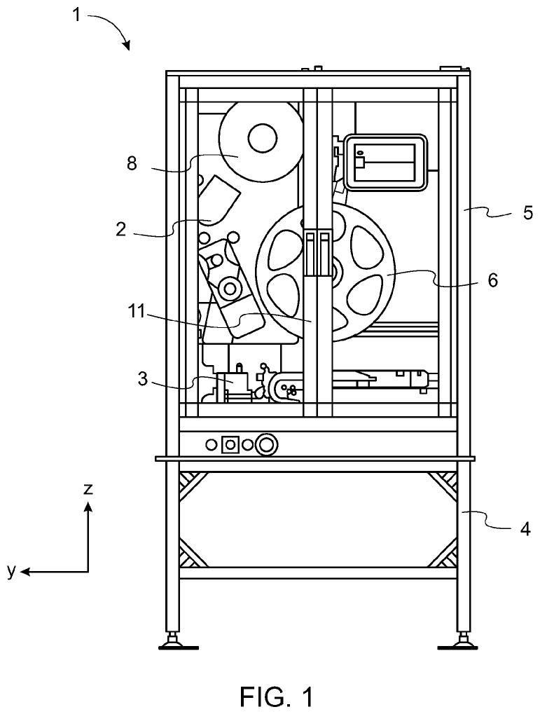

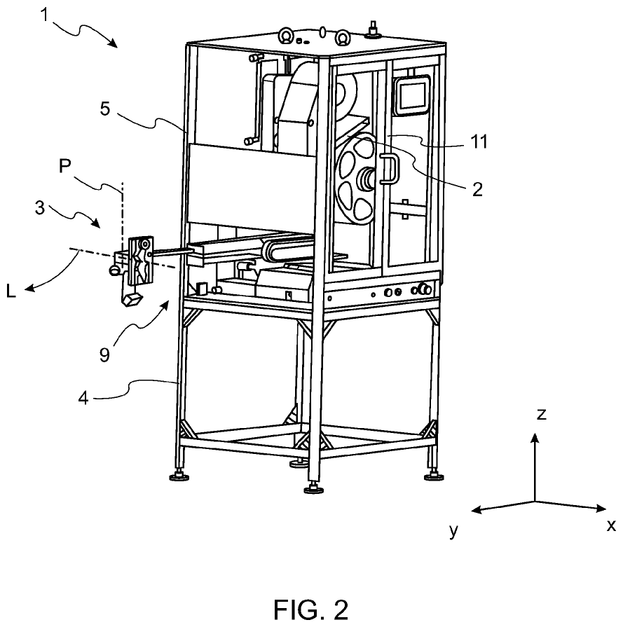

FIGS. 1 and 2 illustrate a pallet labelling apparatus 1 comprising a labelling machine 2, and a label applicator 3 for applying labels to a pallet. The pallet labelling apparatus 1 is mounted to a support structure 4 elevating the labelling apparatus 1 off the ground to a desired operating height so that the applicator 3 can apply labels to pallets positioned on a conveyer (not shown). Extending above the support structure 4, a housing 5 encloses the applicator 3 when it is in a retracted configuration (FIG. 1). The housing 5 also encloses the labelling machine 2. The pallet labelling apparatus may be referred to as a system, or a pallet labelling system.

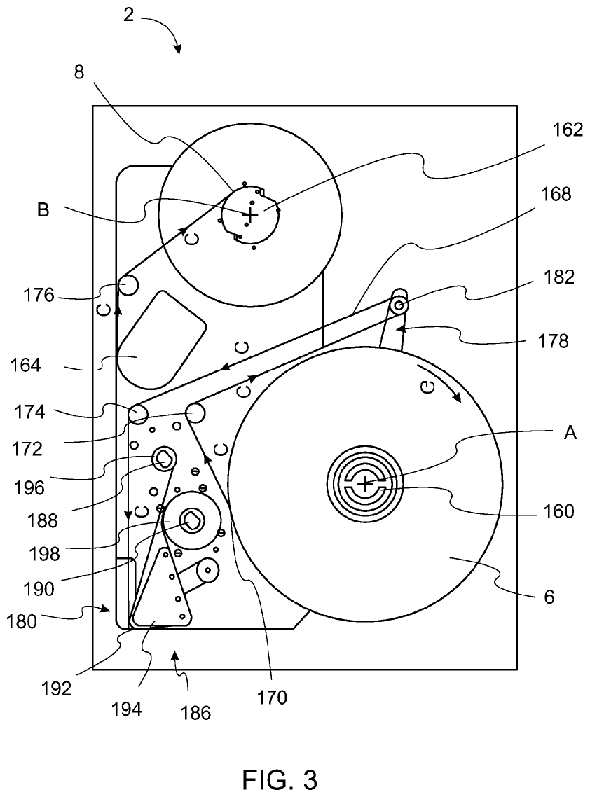

The labelling machine 2 may comprise a labelling machine of the sort described in WO2010/018368, WO 2014/072727 and/or WO 2015/059447, is shown in more detail in FIG. 3. The labelling machine comprises label web material provided on a label supply spool 6 and conveyed through a labelling station to a label take up spool 8.

The labelling machine 2 includes a supply spool support 160 and a take up spool support 162. The supply spool support 160 and take up spool support 162 are both mounted for rotation about respective axes A and B. The axes A and B are shown substantially parallel to one another; however, in some embodiments this may not be the case. The take up spool is connected to a motor 164 such that the motor 164 can be powered in order to rotate the take up spool 162 about the axis B. The motor 164 is connected to the take up spool support 162 via a belt (not shown). The supply spool 6 of label stock may be mounted to the supply spool support 160 such that the supply spool support 160 supports the supply spool 6 and the supply spool 6 co-rotates with the supply spool support 160.

As can be seen in FIG. 3, in use, label stock 168 extends between the supply spool support 160 (and in particular the supply spool 6 mounted to the supply spool support 160) and the take up spool support 162. A web path 170 is defined between the supply spool support 160 and take up spool support 162 by various components and, in use, the label stock is transported along the web path 170. First, second and third rollers (172, 174 and 176) define the web path 170 between the supply spool support 160 and take up spool support 162. It will be appreciated that in other embodiments of the labelling machine, components other than rollers may be used to define the web path 170. Suitable components may be those which impart only a small friction force to label stock when label stock contacts it.

The web path 170 is also defined by a dancing arm 178 and a labelling peel beak 180. The dancing arm 178 includes a dancing arm roller 182 mounted at one end of the dancing arm 178.

In use, the label stock 168 extends along the web path 170 from the supply spool support 160 (and in particular from the supply spool 6) around the first roller 172, around the dancing arm roller 182, around the second roller 174, around the labelling peel beak 180, around the third roller 176 and is wound onto the take up spool support to form the take up spool 8.

The dancing arm 178 is a movable element which is rotatable about axis A. That is to say, the axis of rotation of the dancing arm 178 is coaxial with the axis of rotation of the supply spool support 160 (and the supply spool 6).

The labelling machine includes a printer 186. The printer in this case is a thermal transfer printer. However, it will be appreciated that other embodiments of labelling machine according to the present invention may include any appropriate type of printer, for example, a thermal printer. The printer 186 includes a ribbon supply spool support 188, a ribbon take up spool support 190, a print head 192 and a ribbon guide member 194. In use, a spool of printer ribbon is mounted to the ribbon supply spool support 188, such that the spool of printer ribbon constitutes a supply spool 196 of printer ribbon which is supported by the ribbon supply spool support 188.

In use, print ribbon from the supply spool 196 passes along a print ribbon path past the print head 192 and is wound on to the ribbon take up spool support 190 so as to form a ribbon take up spool 198. In order for print ribbon to be transported from the ribbon supply spool support 188 to the ribbon take up spool support 190, at least the ribbon take up spool support 190 is connected to a motor such that the motor can rotate the ribbon take up spool support 190.

Because the printer 186 shown in FIG. 3 is a thermal transfer printer, the print ribbon is thermally sensitive such that, as the print ribbon passes the print head 192, at least a portion of the print head 192 can be selectively energised to heat a desired portion of the print ribbon and transfer ink from that portion of the print ribbon to an adjacent substrate. In this case the adjacent substrate is a label that forms part of the label stock 168. During operation of the printer 186, the guide member 194 comprises guide rollers which help to guide the print ribbon as it is transported from the ribbon supply spool support 188 to the ribbon take up spool support 190.

The label stock comprises a web and a plurality of labels attached to the web. The labels attached to the web are separable from the web. The labelling peel beak 180 is configured such that, during operation, as the label stock 168 is transported along the web path 170 past the labelling peel beak 180, the labelling peel beak 180 separates a passing label from the web. The separated label may then be received by a label applicator pad 24. This process may be referred to as a dispensing operation. The labelling machine 2 may be referred to as a label dispenser. The orientation of the label as it is separated from the web may be referred to as a dispensed orientation.

Prior to the label being dispensed, the printer 186 may print a desired image on the label. During operation of the labelling machine, the motor 164 is energised to rotate the take up spool support 8 about its axis B. As this is done, the take up spool support 8 winds label stock 168 onto the take up spool support 8 to form the take up spool. The take up spool 8 will include the web of the label stock. Any labels separated from the web of the label stock as they pass the labelling peel beak 180 will not form part of the take up spool.

The winding of the label stock 168 (and in particular the web of the label stock) onto the take up spool support 8 will cause the label stock 168 to move along the web path 170 in the direction indicated by arrows C (FIG. 3). The winding of the web of the label stock onto the take up spool support 8 causes label stock to be paid out from the supply spool 6 which is supported by the supply spool support 160.

Referring again to FIGS. 1 and 2, the housing 5 is configured to cover all sides of the labelling machine 2 and label applicator 3 (although may comprise transparent portions). In some arrangements, a heater may be provided within the housing to maintain a certain temperature within the housing 5 to accommodate for operational requirements, depending on the type of printing and label being used.

In some arrangements the housing may be omitted entirely. Moreover, the apparatus 1 may be distributed. That is, the apparatus 1 may comprise separate elements (e.g. labelling machine 2 and label applicator 3) that cooperate to perform the methods described herein. That is, the term “apparatus” should not be interpreted to mean a single physically connected apparatus, but rather a system comprising the components necessary to perform the described functions.

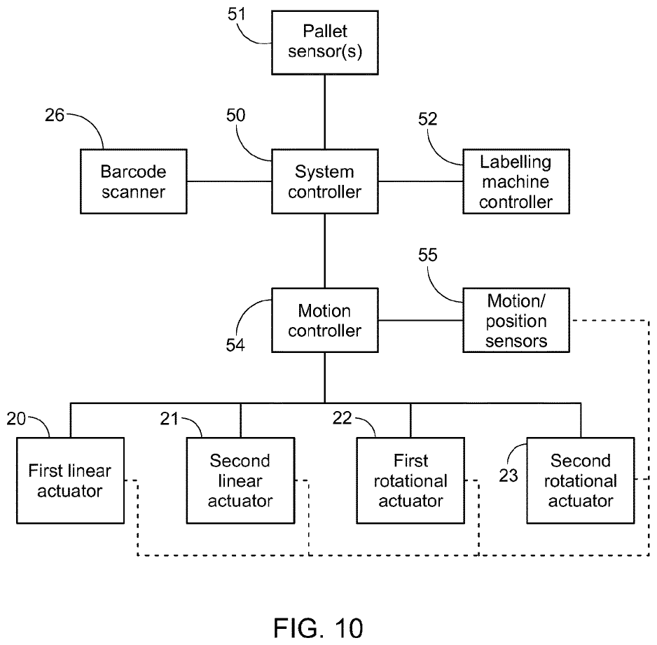

The labelling machine may be controlled by a labelling machine controller 52 (as shown in FIG. 10) that is configured to control printing and dispensing of labels, as described in more detail below.

A pair of doors 11 is provided on a side face of the housing 5, to allow access to the labelling machine 2, e.g. for maintenance and/or replenishment of labels or printer ribbon. An access port 9 is provided on a front face of the housing 5, to allow the applicator 3 to extend from the housing 5 towards a pallet, during labelling operations (described in more detail below). The port 9 is reconfigurable between an open configuration and a closed configuration. For example, the port 9 may be configured to slide between the open and closed configurations. The port 9 may be actuated by any suitable linear actuator known in the art (e.g. a rack and pinion, piston assembly, etc.).

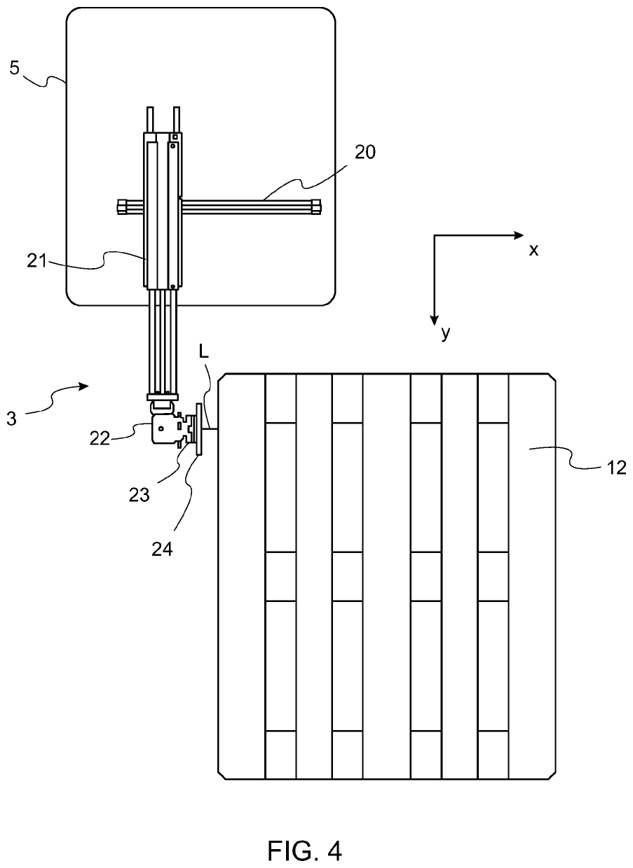

FIG. 4 shows schematically a top view of the label applicator 3, with the labelling machine 2 omitted and only the bottom of the housing 5 included, for clarity.

Components of the label applicator 3 are secured to the housing 5 and support 4 (not shown in FIG. 4), providing a fixed reference. The applicator 3 comprises a first linear actuator 20, a second linear actuator 21, a first rotational actuator 22, a second rotational actuator 23, and a label applicator pad 24. The first linear actuator 20 is connected between the housing 5 and the second linear actuator 21. The second linear actuator 21 is connected between the first linear actuator 20 and the first rotational actuator 22. The first rotational actuator 22 is connected between the second linear actuator 21 and the second rotational actuator 23. The second rotational actuator 23 is connected between the first rotational actuator 22 and the label applicator pad 24.

The first linear actuator 20 and the second linear actuator 21 may each be any appropriate form of actuator, e.g. a rodless cylinder, or a guided linear pneumatic cylinder. The first rotational actuator 22 may be be any appropriate form of rotary actuator, e.g. a three position rotary pneumatic actuator. The actuators may be operated by compressed air supplied by pipes extending from the housing 5. It will be appreciated, however, that alternative actuators may be provided as required.

The first linear actuator 20 is configured to cause the second linear actuator 21, rotational actuators 22, 23 and label applicator pad 24 to move relative to the housing 5 in an x-direction (see axes in FIG. 4). The second linear actuator 21 is configured to cause the rotational actuators 22, 23 and the label applicator pad 24 to move relative to the housing 5 (and the first linear actuator 20) in a y-direction (see axes in FIG. 4). The first rotational actuator 22 is configured to cause the label applicator pad 24 to rotate relative to the housing 5 about a label placement axis P (see FIG. 2) that is parallel to the z-direction. The label placement axis P may be referred to as a vertical axis.

The second rotational actuator 23 is configured to cause the label applicator pad 24 to rotate relative to the housing 5 about a label orientation axis L that is aligned with the x-axis in configuration shown in FIG. 4 (but changes, depending on the extent of rotation about the axis P). The label orientation axis L is substantially normal to the plane of the label. In the illustrated example, the label orientation axis L passes through a centre of the label applicator pad 24.

In this way, the label applicator 3 is configured to allow the label applicator pad 24 to be positioned so as to receive a label from the label dispenser (i.e. the labelling machine 2) and to move the label applicator pad 24 (and a supported label) so as to cause the label to be applied to an article (e.g. an article placed on a pallet 12).

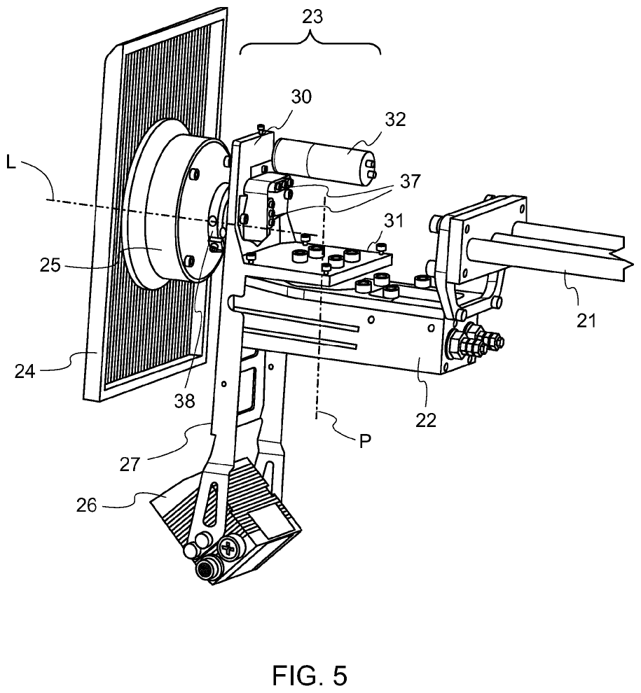

FIG. 5 shows the components coupled between the second linear actuator 21 and the applicator pad 24 in more detail, and also shows the vertically aligned label placement axis P, and label orientation axis L.

The label applicator 3 further comprises a barcode scanner 26, which is configured to read barcodes to GS1 standards. The barcode scanner 26 may comprise one or more of a line scanner, a two-dimensional scanner, a radio frequency identification (RFID) scanner and a camera device. The barcode scanner 26 is supported on a mounting bracket 27, which is configured to rotate about the label placement axis P with the label applicator pad 24, but which is in a fixed position relative to the label orientation axis L.

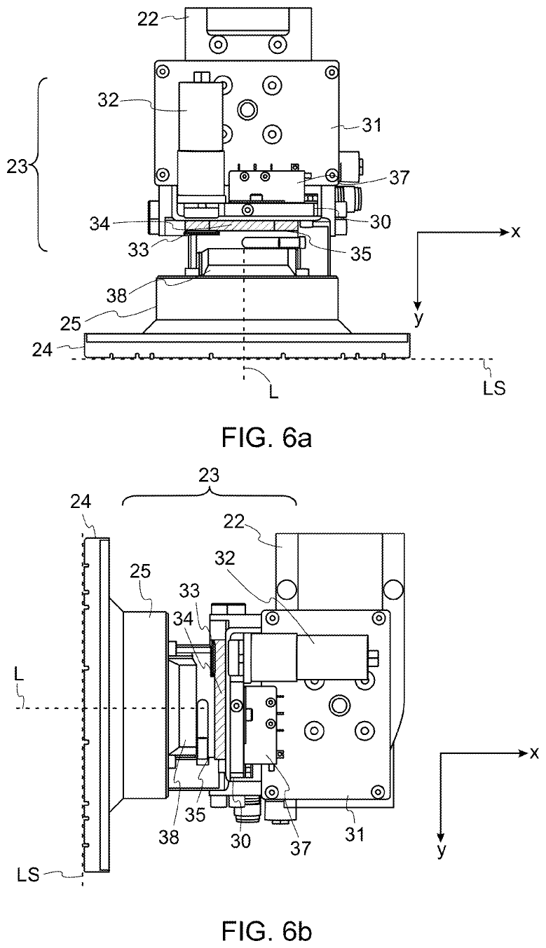

FIGS. 6a and 6b illustrate the operation of the first rotational actuator 22. In particular, in FIG. 6a the first rotational actuator 22 is configured such that the label applicator pad 24 is oriented such that a label support plane LS defined by the label applicator pad 24 is parallel with the x-axis. In contrast, in FIG. 6b the first rotational actuator 22 is configured such that the label applicator pad 24 is oriented such that the label support plane LS of the label applicator pad 24 is parallel with the y-axis, having been rotated through 90 degrees in a clockwise direction. In a third configuration (not shown) the label applicator pad 24 can be oriented such that the plane of the label applicator pad 24 is parallel with the y-axis, having been rotated through 90 degrees in an anti-clockwise direction from the configuration shown in FIG. 6a.

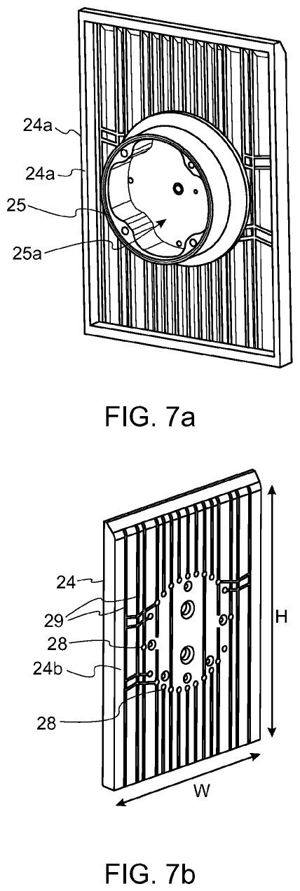

Referring to FIGS. 7a and 7b, the label applicator pad 24 has a generally rectangular shape, having a height H that is greater than a width W. The label applicator pad 24 has a first side 24a and a second side 24b. The first side 24a comprises a mounting cylinder 25, which connects to the second rotational actuator 23. The second side 24b is configured to support a label which is to be applied to an article, and defines the label support plane LS (see FIGS. 6a, 6b).

The label applicator 3 further comprises a vacuum source (not shown) provided in communication with the mounting cylinder 25, and configured to cause a vacuum to be generated within an internal cavity 25a defined by the mounting cylinder 25 (see FIG. 7a). A plurality of holes 28 are provided through the label applicator pad 24, allowing air to flow into the internal cavity 25a from the second side 24b of the label applicator pad 24. The second side 24b of the label applicator pad 24 further includes a series of longitudinal slots 29 permitting an airflow to pass therethrough.

In a first configuration, when a vacuum is applied to the internal cavity 25a, a label can be drawn into contact with the side 24b of the label applicator pad 24. Once the label is in contact with the label applicator pad 24, the vacuum source provides a suction effect to temporarily hold the label against the label applicator pad 24. Furthermore, in a second configuration, the vacuum source is disabled, allowing a label to be applied to an article.

In an alternative arrangement, one or more fans could be integrated within the applicator pad 24 to provide suction. In a further alternative the vacuum source could be provided within the housing 5.

Referring again to FIGS. 5, 6a and 6b further detail of the second rotational actuator 23 can be understood. The applicator pad 24 is supported by a first mounting plate 30 that is connected to the bracket 27. The first mounting plate 30 is connected to the output of the first rotary actuator 22 by a second mounting plate 31. A drive motor 32 is secured to the first mounting plate 30. The drive motor 32 drives a first gear 33, which is coupled via a drive belt 34 to a second gear 35. The second gear 35 is rotatably mounted to the first mounting plate 30. The first and second gears 33, 35 may provide a gear reduction (e.g. 4:1) from the motor drive 32. The drive motor 32 may be a stepper motor, and may itself comprise a reducing gearbox. Micro-switches 37 are provided to detect rotation of the label applicator pad 24, and to provide signals to the motion controller to limit the extent of rotation. The micro-switches 37 are examples of position sensors.

The second gear 35 is further coupled to the applicator pad 24, via a gimbal assembly 38. The gimbal assembly 38 is secured to the mounting cylinder 25, and allows the applicator pad 24 to move to a limited extent to allow close conformance with a surface to which a label is being applied, while transferring rotational movement from the gear 35 to the applicator pad 24. The gimbal assembly may be omitted in some arrangements.

In alternative arrangements, any suitable motor and gearing system may be used. Alternatively, the rotation of the label applicator pad 24 may be provided by a pneumatic or other electro-mechanical actuator (e.g. a solenoid).

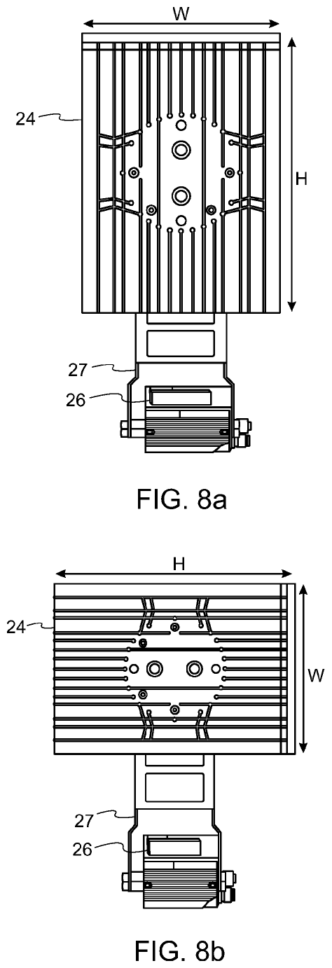

The second rotational actuator 23 is configured to rotate the applicator pad 24 about the label orientation axis L. The applicator pad 23 may be configured to rotate from a portrait orientation, as shown in FIG. 8a to a landscape orientation, as shown in FIG. 8b. That is, the extent of rotation may be limited to 90 degrees in only one direction (although in other embodiments a greater extent of rotation may be preferred, e.g. +90 degrees).

In use, the label applicator 3 is capable of applying labels to various surfaces of articles stacked on a pallet 12, in various orientations. As described above, the first and second linear actuators 20, 21 allow the label actuator pad 24 to be moved in the x- and y-directions to any arbitrary position within the operational limits of each actuator.

In an embodiment, the first linear actuator 20 may allow a range of movement in the x-direction of up to 500 mm, the second linear actuator may allow a range of movement in the y-direction of up to 700 mm. Of course, different ranges of movement may be provided as required by specific labelling applications.

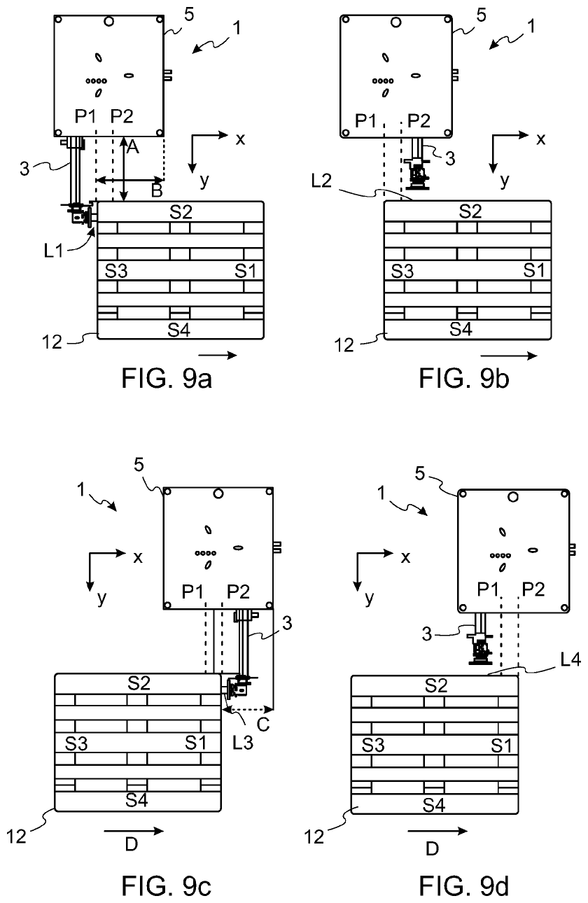

In order to apply labels to different surfaces of articles stacked on a pallet adjacent to the pallet labeller 1, the first rotational actuator 22 permits rotations about the label placement axis P between three positions, as described in more detail below with reference to FIGS. 9a-9d. Finally, in order to apply a label in either of a portrait or a landscape orientation, the second rotational actuator 23 permits rotations between two positions 90 degrees from one another about the label orientation axis L.

As shown in FIGS. 9a-9d, a pallet 12 may move in a movement direction D past the pallet labeller 1. The pallet 12 is shown without any articles stacked thereon, but in normal operations, the pallet 12 may comprise a pallet base (as shown) with a plurality of articles (e.g. boxes) stacked thereon, and wrapped in a plastic film for secure transport.

The packed pallet has a first side S1, which leads in the movement direction D, a second side S2, facing the pallet labeller 1, a third side S3, which trails in the movement direction D, a fourth side S4, facing away from the pallet labeller 1. The pallet labeller 1 may be capable of applying a label to each of the first, second and third sides S1, S2, S3. For example, FIG. 9a illustrates the label applicator 3 applying a label to the pallet 12 at a first location L1, on the third side S3 of the pallet 12. In this scenario, the label applicator pad 24 is in a first orientation aligned with the third side S1 of the pallet 12, and first and second linear actuators 20, 21 are configured to move the label applicator pad 24 to minimum position in the x-direction, and an extended position in the y-direction. FIG. 9b illustrates the label applicator 3 applying a label to the pallet 12 at a second location L2, i.e. on the second side S2 of the pallet 12. In this case, the label applicator pad 24 is in a second orientation aligned with the second side S2 of the pallet 3 (at 90 degrees relative to the first orientation, rotated about the vertically aligned label placement axis P). Compared to the position shown in FIG. 9a, the first linear actuator 20 has caused a positive movement in the x-direction, and the second linear actuator 21 has caused a negative movement in the y-direction.

FIG. 9c illustrates the label applicator 3 applying a label to the pallet 12 at a third location L3, i.e. on the first side S1 of the pallet 12. In this case, the label applicator pad 24 is in a third orientation aligned with the first side S2 of the pallet 3 (at 180 degrees relative to the first orientation, rotated about the vertically aligned label placement axis P). Compared to the position shown in FIG. 9b, the position has not changed in the x-direction, but the second linear actuator 21 has caused a positive movement in the y-direction.

Finally, FIG. 9d illustrates the label applicator 3 applying a label to the pallet 12 at a fourth location L4, i.e. on the second side S2 of the pallet 12. In this case, the label applicator pad 24 is again in the second orientation aligned with the second side S2 of the pallet 3 (at 90 degrees relative to each of the first orientation and the third orientation). Compared to the position shown in FIG. 9c, the first linear actuator 20 has caused a negative movement in the x-direction, and the second linear actuator 21 has caused a negative movement in the y-direction.

It can be seen that to apply labels to each of the first and second locations L1, L2, the rear side of the pallet S3 should be aligned with the position P1. On the other hand, to apply labels to each of the third and further locations L3, L4, the front side of the pallet S1 should be aligned with the position P2.

In some embodiments, it may be preferred to label at three, or even four, locations from L1-L4. In such circumstances, a pallet 12 should first be stopped so that the leading side S1 is level with the second positon P2, while labels are applied at one or both of the third and further locations L3, L4. Then, the pallet 12 should be advanced in the movement direction D before being stopped so that the trailing side S3 is level with the first positon P1, while labels are applied at one or both of the first and second locations L1, L2.

Photo sensors (not shown) or other means may be provided to indicate the presence of a pallet at the first or second positions P1, P2.

It will be appreciated, however, that while only four configurations of the label applicator 3 are illustrated in FIGS. 9a to 9d, the label applicator 3 may be configured to apply the label at other locations within an operational range.

With reference to FIG. 10, a system controller 50 is configured to communicate with a pallet sensor 51, associated with a pellet conveyer (not shown). The pallet sensor 51 is configured to send a signal to the system controller 50 to indicate whether an article (e.g. a pallet 12) is positioned on the conveyer at the first and/or second positions P1, P2. The system controller 50 is also in communication with a labelling machine controller 52 to control printing and dispensing of labels. For example, if the pallet sensor 51 sends a signal to the system controller 50 to indicate that a pallet 12 is positioned on the conveyer with leading edge at the second positon P2, the system controller 50 may instruct the labelling machine controller 52 to print a label for applying to the pallet 12. The system controller 50 may communicate with a motion controller 54 to cause the label applicator 3 to move the label applicator pad 24 to a position to receive the label from the labelling machine 2 (although it may already be provided in such a location).

Once the label has been printed and dispensed, the system controller 50 may communicate with the motion controller 54 to cause the label applicator 3 to move the label applicator pad 24 so as to apply the label at one of the third and further locations. These operations may continue until each of the required labels has been applied to the pallet 12.

The motion controller 54 is configured to control the first and second linear actuators 20, 21, and the first and second rotational actuators 22, 23. One or more sensors 55 may be associated with the linear and rotational actuators (e.g. micro-switches 37), allowing the motion controller 54 to determine when an actuator has reached a desired position.

The barcode scanner 26 is also configured to communicate data to the system controller 50. The data may be data indicative of an image or barcode quality of the printed label. The barcode scanner 26 may obtain such data before the label has been transferred to the label applicator pad 24 (i.e. before it has been dispensed from the labelling machine 2) and/or after the label has been applied to the pallet 12. Such data may enable a defective barcode to be identified.

The system controller 50 may be configured to receive label image data 200d from an industrial control system (not shown).

It will be appreciated that different functions may be performed by different parts. For example, the system controller 50, motion controller 54 and labelling machine controller 51 may all be provided by a single controller, by multiple controllers or processors located in a common location (e.g. within the housing 5).

Similarly, alternative label applicator systems may be provided. For example, in some embodiments, z-axis movement may be provided, whereas in others a reduced extent of movement may be required. For example, an applicator may move only in a single linear direction (e.g. towards and away from a labelling location). In some examples, a pivoting movement may be provided to move labels relative to a labelling location.

Additionally, or alternatively, in some embodiments, motor controlled actuators may be provided, while in other embodiments a robotic arm (e.g. a 6-axis robotic arm) may be provided. Generally speaking, the type of actuators used, or the degrees of freedom provided, will depend upon the particular labelling application. However, in each a case, the label applicator will be able to apply a dispensed label to an article in an application orientation, as described in more detail below.

As described above, the purpose of applying labels to pallets using the system described herein is to enable information associated with the contents of the pallet, or the destination to which the pallet should be shipped (amongst other things) to be provided on the pallet in a readily accessible format. It is important, therefore, within a label print and applying apparatus, to provide robust quality control measures, and also to provide a high degree of confidence that a label applied to a product accurately reflects the information that is intended to be contained within the label.

A GS1 compliant barcode is usually printed vertically on a portrait label. That is, each of the bars in the barcode is arranged vertically, in the same orientation as the longer length of the portrait label.

In order to avoid significant unnecessary expense, it is conventional for a printer to be provided which is capable of printing across the full-width of a portrait oriented label. In order to print a full-width of the portrait label a narrower printhead is required than would be required if it was required to print across the full width of a landscape oriented label. For example, if a label size is 100 mm by 150 mm, a printhead which is capable of printing across the full width of the 100 mm width will be sufficient to enable a full label to be printed. This avoids the need to provide printers with an unnecessarily wide (and expensive) printhead.

It can be understood therefore that as a barcode is printed in the above described orientation, as the barcode is printed a vertical stripe within the barcode will be printed by the same one or ones of the printing elements disposed across the width of the printhead. This orientation of the barcode may be referred to as a “picket-fence” orientation, or a first printing orientation.

It will further be understood therefore that if a single one of the printing elements within a printhead fails, then the entire barcode printed in a picket-fence orientation may become unreadable. Furthermore, should a number of printing elements fail then several vertical lines within the barcode may be affected.

It has long been known to adjust the horizontal position of a barcode in order to accommodate known printer defects within regions of blank space within a barcode. That is, it may be possible to “march” a barcode left or right by an amount which allows known printing defects (e.g. failed printing elements) to fall within regions where no printing is required for that particular barcode. In this way, it has been possible to reduce defects when printing barcodes.

As described above, it is common for a printed label to include more than one barcode. Furthermore, both barcodes may be stacked one upon the other. In such an arrangement, it may be that a single defective printing element makes it difficult, or even impossible, to adjust the image in such a way that a blank vertical line can be found which runs through both barcodes and which can accommodate the defective printing element. Furthermore, as the number of printing defects increases, the difficulty of adjusting the printed image to accommodate such defects increases too.

Further still, while it may be possible to find a suitable adjustment for a single printed label, when each printed label is different (e.g. with each label having a unique serial number). A new assessment of possible image shifts may be required to be performed for every single label which is printed.

In view of the above, when a certain level of defectivity exists within a print head, it may be very difficult to print picket-fence barcodes to an acceptable level of quality for effective reading during subsequent distribution.

As described above, the label applicator 3 of the pallet labelling apparatus 1 described herein allows labels to be manipulated in a variety of different ways. One of the ways in which it can be manipulated is to rotate the label applicator pad 24. This enables the label to be rotated from a first orientation (e.g. a portrait orientation-FIG. 8a), to a second orientation (e.g. a landscape orientation-FIG. 8b). Furthermore, it has been realized that whereas it is conventional to print labels in a portrait manner (with a “picket-fence” oriented barcode), and to apply them to a pallet in a similar portrait manner, it is possible to also apply labels in a landscape manner. Further still, it has been realised that where printing quality defects exist due to defective printing elements, high quality images, or at least images of sufficiently high quality to enable barcodes within them to be read, can be printed by rotating the image to be printed such that the label is in a landscape orientation when applied.

As described above, a portrait printed label may include a barcode which is printed vertically in a picket-fence orientation (i.e. the first printing orientation). However, a barcode which is printed laterally with respect to the printing elements may be referred to as a “ladder” barcode, or a second printing orientation. In particular, each line within the barcode may correspond to an individual line of printing which is performed at any point in time, with each line of the barcode printed sequentially, rather than having a part of every line of the barcode being printed in parallel. Such ladder barcodes may be relatively immune to print quality defects caused by defective printing elements, since a defective printing element will result in a horizontal stripe across the finished barcode, which will run perpendicular to the orientation of the bars within the barcode. Whilst such a defect may be visible to the human eye, it will not generally interfere with the ability of a barcode scanner to read the barcode. As such, a ladder printed barcode can avoid issues described above associated with defective printing elements. By rotating the image to be printed on the label, it is possible to cause a barcode to be printed in ladder arrangement, rather than picket-fence arrangement.

Such a rotation of the image to be printed on the label may require some adjustment of image elements or components within the label. Such a reorientation of the label image can be performed by a system controller 50 of the apparatus 1. Rotation of an image to be printed on a label may refer either to the rotation of a complete image, or to the rotation of one or more image components, as well as the adjustment of those image components within the label.

Defective printing elements may occur for a number of reasons. For example, printing elements can fail after being used for a period of time. In more detail, printing elements within a thermal transfer printer, or a thermal printer, (either of which can be used within a label printer) generally comprise plurality of resisters, each resister being energized during a printing operation to print a pixel. During operation, a printing element may be successively cycled on and off, and will be heated to a high temperature and then cooled again rapidly during each cycle. Successive cycling of printing elements can ultimately result in failure of one or more printing elements within a print head. Defective printing elements may be referred to as “dead dots”. The defective elements can be detected by a process such as that described in WO 2015/052540. By performing a defective element detection process of this sort, it is possible to generate a map (e.g. a dead-dot map) associated with a print head. A map of this sort can then be used to attempt to avoid relying on printing with defective printing elements to print a barcode. During the label printing process, each label image can be compared with a dead dot map to identify likely print quality issues before printing has taken place.

Further, or in addition, as described above, the label applicator 24 of the present labelling apparatus 1 comprises the barcode scanner 26. The barcode scanner may be configured to allow a barcode to be imaged or scanned by the apparatus 1, for example during the dispensing process. For example, an image of a barcode may be captured while the label has been partly dispensed and before the label applicator pad 24 has collected the label from the label dispenser. Such pre-dispensing scanning may enable a defective barcode to be identified immediately after printing but before application to a product (e.g. a pallet).

While failed or dead dots may be recognisable via a defective element detection algorithm as described above, printing elements may also become dirty during use. As such, even while a printing element may be operating correctly, debris located on the surface of the printing element may prevent effective printing from taking place with that particular printing element. In such circumstances, the printing element or printing elements may become operationally defective even if they are still electrically operational. As such, by scanning a barcode that has been printed but before label collection, it is possible to identify defective barcodes and prevent them from being applied to a pallet.

If either of the above described processes identifies a defective barcode (i.e. a barcode which has a print quality insufficient to allow proper information retrieval) on a label printed (or to be printed) in the first printing orientation, the image for printing may be rotated and printed onto a fresh label in the second printing orientation. The label can then be applied to the pallet in a rotated (i.e. second) application orientation as described above. That is, the printing orientation and the application orientation are controlled in dependence upon a measure of image quality (e.g. data indicative of image quality).

It will be understood that if a determination has been made to rotate a label after a defective label has already been printed, the defectively printed label may be collected and discarded, for example by applying the defective label to a predetermined discard location. Alternatively, if the label has been applied to the pallet and is read in situ, and if it is determined at that stage that it is defective, a replacement label may be printed and applied over the top of the original label. It will be further understood that since the first label may be applied in a portrait manner on the pallet (i.e. the first application orientation), and a replacement label may be applied in a landscape orientation (i.e. the second application orientation) on the pallet, an intermediate blank label may be applied in a portrait manner on top of the first (i.e. defective) label so as to avoid any risk of parts of the label which include defective printing from being read during subsequent reading operations.

It will be further be understood that one or more of the print quality determination processes as described above can be performed during each labelling operation. On the other hand, one or more of the print quality determination processes as described above can be omitted during some labelling operations.

For example, where it has previously been determined that the defective elements exist which will inevitably result in a print quality issue, it may be decided to rotate each image before printing and printing all labels in the second printing orientation until remedial action has been taken (e.g. printhead inspection, cleaning or replacement). In such circumstances, it may not be possible to scan a barcode that has been printed prior to collection. In particular, since a ladder-style barcode will be dispensed gradually from the dispensing position in an orientation that is rotated with respect to the orientation of the barcode scanner 26 it may not be possible to read the barcode prior to collection. In such circumstances it may be assumed that the barcode is of sufficient quality to enable subsequent reading. Alternatively, the barcode may be read once it has been applied to the product. It will, of course, be appreciated that where a barcode has already been printed in a rotated manner (i.e. in the second printing orientation), it may not be possible to rotate the image further in order to improve print quality. That is, if a rotation has been performed in order to improve print quality, but print quality is still insufficient, some alternative action may be required in order to improve print quality. For example, cleaning of the printhead, or even replacement of the printhead may be required.

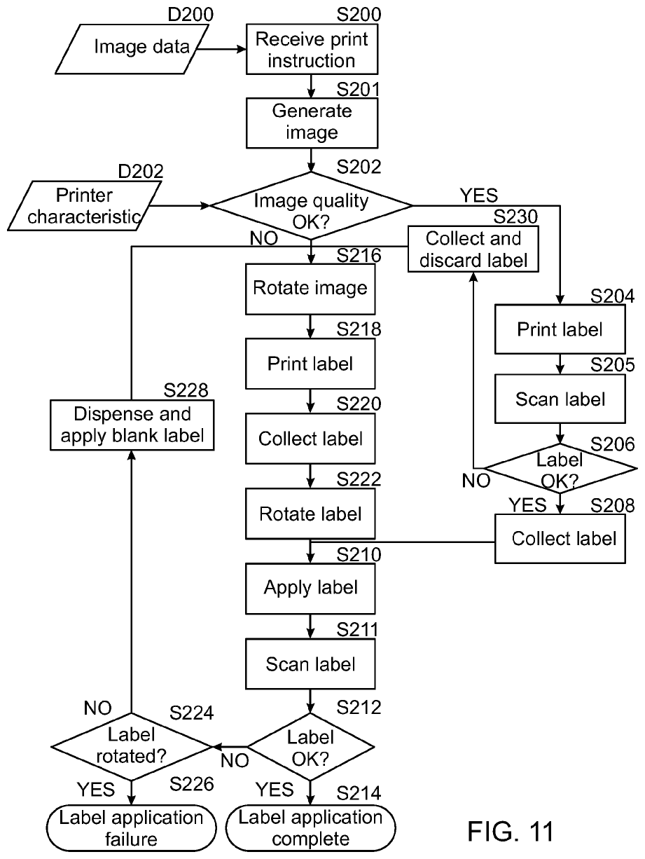

A process performed by the controller 50 by which labels can be printed, (selectively) rotated, and applied is now described with reference to FIG. 11. At step S200 a print instruction is received by the controller 50. The print instruction may include sufficient information regarding the content and layout of a label (e.g. image data D200) to enable the final label image to be generated. For example, various data fields may be provided in image data D200 which can be assembled in combination with a label template obtainable from a memory associated with the controller 50 to generate a final label print image. Such a label print image is generated electronically at step S201. The generated label print image may then be assessed at step S202 with reference to printer characteristic data D202 (e.g. a dead dot map) to determine if an expected print image quality issue exists. The printer characteristic data D202 may be generated as required (e.g. by performing a defective printing element detection process), or may be obtainable from a memory associated with the controller 50. The processing at step S202 may thus generate data indicative of image quality, which data comprises data indicative of an expected image quality. Based upon this data, the determination may be made as to whether the data indicative of image quality meets a predetermined criterion. The predetermined criterion may be that a barcode within the image to be printed can be read by a barcode scanner (i.e. a “pass”). The predetermined criterion may be referred to a predetermined expected criterion, since it relates to the expected print quality. The data indicative of (expected) image quality may be considered to be associated with a label which is yet to be printed.

If it is determined at step S202 that there is no print quality issue likely to occur (taking into account printer characteristic data D202), processing passes to step S204 where the label is printed in a conventional (i.e. portrait) mode. That is, if the predetermined criterion is met and the barcode within the image to be printed is considered likely to be of sufficient quality to read by a barcode scanner, the label is printed by the label printer 186. By default, the printing is carried out in the first printing orientation, for example with barcode bars are arranged as to be aligned with the direction along which the label is moved past the printhead. Where the label is a portrait label (i.e. with its length in a movement direction is greater than its width), the barcode bars are aligned with the longer label direction (i.e. its height).

Once the label had been printed processing passes to S205 where the label is scanned using the barcode scanner 26 associated with the label applicator 3. The processing at step S205 may thus generate further data indicative of image quality. The scanner is configured to generate sensor data indicative of a characteristic (e.g. a barcode) of an image printed on the label. The sensor data may be an image of the barcode, and the data indicative of image quality may be an indication of a quality of the barcode, derived from the sensor data.

A determination is then made at step S206 regarding the label quality. The determination may be made as to whether the data indicative of image quality meets a predetermined criterion. The predetermined criterion may be that a barcode within the printed image can be read by the barcode scanner (i.e. a “pass”). The predetermined criterion may be referred to a predetermined printed criterion, since it relates to the quality of a printed image. The data indicative of (printed) image quality may be considered to be associated with the label which has now been printed.

If it is determined that the scanned label is of acceptable quality (based on the printed image), based on the scanned image, processing passes to step S208 where the label is dispensed by the label dispenser and collected by the applicator pad 24 (which is moved by label applicator 3). The label may be dispensed in a label dispensing orientation, that is, the orientation in which the label moves as it is separated from the label web as it moves last the peel beak 180.

The label can then be applied at step S210 in an application orientation. In the example described, the application orientation is a first application orientation, which is a portrait orientation, and which corresponds to the same orientation in which the label was printed (i.e. the first printing orientation) and dispensed (i.e. the dispensing orientation).

After the label has been applied, the label is scanned again by the barcode scanner 26 at step S211. A further determination is then made at step S212 regarding the label quality. The determination may be made as to whether the data indicative of image quality meets a predetermined criterion. The predetermined criterion may be that a barcode within the image printed can be read by the barcode scanner (i.e. a “pass”). The predetermined criterion may be referred to a predetermined applied criterion, since it relates to the quality of an image on a label which has been applied to an article. If it is determined that the applied label is of acceptable quality (i.e. a “pass”), based on the scanned image, processing may then complete at step S214.

Referring again to step S202, if the processing performed determines that the known printer characteristic (e.g. dead dots) is likely to cause a defective print (i.e. a “fail”), then processing passes to step S216, where the image to be printed is rotated. The image to be printed may be rotated by 90 degrees.

It will be understood that rotating the image will typically not simply comprise rotating each element of the image, or the image as a whole. However, the information provided within the label image (e.g. image data D200) may be re-organised to be accommodated within an alternatively arranged (e.g. landscape) label template. This processing to decide to rotate the image to be printed may be referred to as determining that the printing orientation and the application orientation should be a second printing orientation and a second application orientation respectively. That is, the printing orientation and the application orientation may both be changed in a coordinated manner.

Once this image processing step has been performed, processing passes to step S218 where the rotated image may be printed on a label in a landscape format (i.e. the second printing orientation). Processing then progresses to step S220 where the label is dispensed (in the dispensed orientation) and collected by the applicator pad 24. It will, of course, be appreciated that it is not possible to scan the label prior to collection in this instance, due to the orientation being transposed with respect to the barcode scanner 26.

Once the label has been collected at step 220, the label can be rotated at step S222 in order to provide the barcode in a horizontal orientation before application (since this is expected orientation for barcode scanning). The label may be rotated by 90 degrees (i.e. the same rotation as applied to the image at step S216).

Once the label has been rotated the label can be applied at step S210 in the second application orientation. Apart from the orientation, the application process is substantially as described further above (although with the label applicator pad 24 now in a landscape orientation). The label can then again be scanned at step 211, assessed at step S212, and processing passed to step S214 if the scanning process indicates adequate print quality.

If, on the other hand, the processing as described at S212 results in a determination that the label is of insufficient quality to be subsequently read (e.g. if the predetermined applied criterion is not met and the determination has a “fail” outcome), processing then progresses to step S224. At step S224 it is determined if the label has previously been rotated (i.e. was the label previously applied printed in the second printing orientation, and applied in the second application orientation). This determination may be equivalent to determining if the application process followed steps S216 to S222. If it is determined that the label has already been rotated, processing terminates at step S226, where it is declared that a label application failure has occurred. This processing outcome may be used to generate an alert to an operator informing them that the printed labels are of insufficient quality to be read, and advising them to perform some maintenance or investigative work.

On the other hand, if it is determined at step S224 that the non-rotated labelling branch (i.e. the branch including steps S204-208) had been followed for the applied label (i.e. the label previously applied was printed in the first printing orientation, and applied in the first application orientation), processing may pass to step S228 where a blank label is dispensed and placed over the previously applied label on the pallet.

Processing then passes to step S216, where the label image is rotated (S216), printed (S218), collected (S220), rotated (S222), and applied (S210) in landscape fashion (second application orientation) over the original portrait label. This processing may constitute a determination that the printing orientation and the application orientation should be a second printing orientation and a second application orientation respectively. That is, the printing orientation and the application orientation may both be changed in a coordinated manner if a label has previously been printed and applied in the first orientation.

It will be understood that even if a (first) label has previously been printed and applied in the first orientation, it is possible for the processing at step S216 to amount to a determination of the application orientation based on data indicative of image quality that has been determined at step S212. The (second) printing step at step S218 may then be considered to constitute the label printer being caused to print the image on the label in the printing orientation (in this case, the second printing orientation).

As described above, the provision of a blank label between the original defective portrait label and the replacement landscape label ensures that no information can be read from the original label. Of course, such a provision of a blank label may not be required in certain circumstances, e.g. where the placement of the replacement label can be guaranteed to cover crucial information. As such, processing step S228 may be considered to be optional.

As has been described above, processing branch S204-208 provides for a non-rotated label to be printed where the printer characteristic data D202 indicates that there are not significant label quality issues to be expected. Of course, it is possible, as described above, that other print quality issues exist that can result in a label printed in this way being defective. Such print quality issues can be detected by the scanning performed at step S206. It has previously been described that if the scan results in a confirmation of sufficient print quality, the processing passes to step S208. On the other hand, if the scanning performed at step S206 identifies insufficient print quality, processing may pass to step S230 where the printed label may be collected and discarded. Processing may then proceed to step S216 where the image can be rotated (S216), printed (S218), collected (S220), rotated (S222), and applied (S210) in a landscape manner.

It will be understood that the above described processing describes several different determinations of label print quality. Each of these determinations (i.e. those performed at steps S202, S206 or S212 may be considered to be a determination of data indicative of image quality. That is, a determination of data indicative of image quality may include processes performed before an image has been printed (for example by using a dead dot map at step S202), or after an image has been printed (for example at step S206, or at step S212).

Further, determination of an expected print quality for example based on knowledge of a dead dot map, may be considered to be a determination made based on data indicative of a characteristic of the printer. Such data indicative of a characteristic of the printer, may itself comprise data indicative of a characteristic of a printhead of the printer, or data indicative of a characteristic of a plurality of printing elements associated with the printhead. The data indicative of a characteristic of a plurality of printing elements may comprise a binary representation for each of the printing elements indicating a “defective” or a “normal” characteristic of the respective printing element. Alternatively, such data may comprise a resistance value associated with each printing element. A resistance value above a certain pre-determined threshold may be considered to be indicative of a defective printing element.

Various processes that are performed prior to S216 (whether based on scanned printed image after printing, or an expected image quality before printing) may be considered to be determinations that an image should be rotated. More generally, such processing may be considered to be a determination of an application orientation based on data indicative of print image quality.

On the other hand, a determination at step S206 that a label printed at step S204 should be collected and applied may constitute a determination of an application orientation based on data indicative of print image quality. That is, a candidate label which has been printed can have its application orientation confirmed (or determined) after printing when it has been established that the printed image quality is sufficient.

Processing described above describes that processing is performed by controller 50. It will be appreciated, however, that various controllers may be used to perform different parts of the processing. Further, some of the steps described herein as being performed by a controller may be performed by a user.

For example, image quality determinations may be made by a processor associated with the barcode scanner 26 (e.g. by a processor provided within the label applicator pad 24. The image quality data provided to the controller 50 may thus be a “pass” or “fail” determination generated by the processor associated with the scanner (which may encompass a barcode verifier, or a barcode reader). The processor associated with the scanner may also pass data that has been read from the barcode to the controller 50 (if a “pass” determination has been made).

On the other hand, where the barcode scanner 26 is implemented as a different type of sensor (e.g. a camera, or linear array), the data provided to the controller 50 may be image data, which is processed by the controller 50 to generate the data indicative of image quality. The controller may thus receive an indication of image quality in the form of image data, and then generate data indicative of image quality (e.g. a “pass” or “fail” determination) itself.

The barcode scanner 26 may also comprise a barcode verifier, or a barcode reader.

Alternatively, or in addition, processing to control the label applicator 3 may be performed at different locations. For example whereas the controller 50 may determine that a label should be applied in a particular location, or in a particular orientation, a further controller (or controllers) associated with the label applicator 3, or parts thereof, may be configured to effect the labelling or rotation process.

In a further alternative, a determination of printed image quality may be performed by a human operator. Such a determination could result in a user or operator of the labelling apparatus 1 providing an indication of image quality associated with a label to the apparatus via an input interface.

For example a user may select a “rotated” label mode for a single (e.g. next) label, or for all future labels (e.g. until a printhead inspection, cleaning, or replacement operation had taken place). Such a selection may result in the steps S204-S208 being temporarily omitted. Alternatively a user may simply provide an indication that the image quality is not sufficient (with the possible selection of a rotated label mode being performed by a controller of the apparatus).

Such a determination of image quality may be performed in parallel with other determinations (e.g. based on the printer characteristic data D202, or based on a scanned labels).

For example, a user may effectively override a normal or default printing orientation, so as to force all labels to be printed (and applied) in a rotated orientation. Alternatively, or in addition, such a determination of image quality may be performed following printing of a particular label, with a single replacement label being printed (in a second orientation) to replace one that had been determined to be of insufficient quality by a user.

It will be understood, of course, that a user may arrive at a determination of printed image quality by visual inspection of a printed label, or alternatively by use of a barcode scanner (e.g. a barcode reader or a barcode verifier), e.g. a handheld scanner.

In a further configuration, a barcode scanner could be provided separately to the labelling apparatus 1, but may provide an indication of image quality associated with a label to the apparatus 1, either directly, or indirectly (e.g. via an operator).

More generally, the data indicative of image quality and the user input described above are both examples of an indication of image quality.

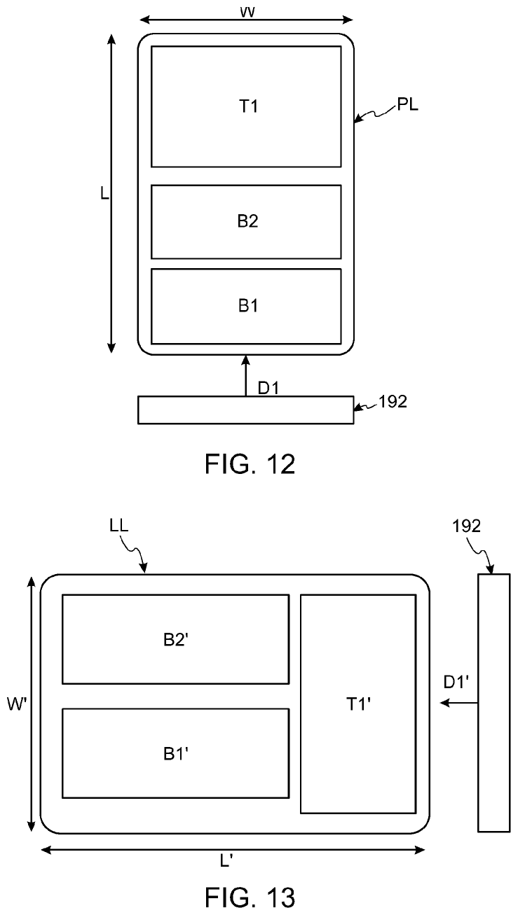

FIG. 12 shows a standard portrait printed label PL comprising a first field T1 holding text information, a first barcode B1 orientated horizontally across the label and a second barcode B2 also orientated horizontally across the label. The barcodes B1 and B2 are both arranged one above the other, with the vertical stripes of the barcode being aligned with a length L of the portrait label, a width W of the portrait label being less than the length L. It will be understood that the width W of the portrait label should generally be no wider than with the printhead 192 so as to ensure that the barcodes and text (or any other image data) can be printed across the full width of the label PL. During printing, the label PL is printed and moved with respect to the printhead in a direction D1, with the barcodes B1, B2 being printed in a picket-fence manner. The portrait label PL has been printed in the first printing orientation.

FIG. 13 shows a landscape label LL which comprises the substantially same information displayed in the label PL. However, each of the first B1′ and second barcodes B2′ are now arranged so that the width of the barcode extends along a length L′ of the landscape label, with the vertical stripes within each of the barcodes B1′, B2′ extending in a direction parallel to a width W′ of the landscape label LL. Text information T1′ has been rearranged so as to sit next to the barcodes B1′, B2′ rather than above them, as was the case with label PL. It will be seen therefore that all of the same information that was provided on label PL has been accommodated on label LL, with a different organisation. Furthermore, during printing the label will be caused to move in a direction D1′ with respect to the printhead 192, with the barcodes B1′, B2′ being printed in a ladder manner. The landscape label LL has been printed in the second printing orientation.

The barcodes B1, B2 and field T1 and barcodes B1′, B2′ and field T1′ are examples of image components that are printed on the labels PL and LL. As shown in FIGS. 12 and 13, the various image components may be rearranged and/or rotated in order to allow the printing orientation to be changed from the first printing orientation (see FIG. 12) to the second printing orientation (see FIG. 13).

Provided the labels PL, LL are applied to articles in the orientation shown (i.e. portrait, or landscape, respectively), it will be appreciated that in each of the first and second printing orientations a particular image component (e.g. barcodes B1, B2, B1′, B2′) can be read by a scanner (e.g. a barcode scanner) after application regardless of the application orientation. This is because in either application orientation, the image (or image component) will have the same orientation. That is, the controller of the apparatus 1 may be configured to determine the printing orientation and the application orientation such that the image component has a predetermined orientation (e.g. horizontal) when applied to the article.

In addition to label layouts PL and LL various alternative label formats may be used. Various templates may be stored within memories associated with the controller 50, or may be provided to the controller 50 along with image data D200.

Further, while the disclosure describes the particular benefits of selective rotation of images containing image components such as conventional barcodes, labels containing other orientation sensitive and typically machine readable image components may be subject to the same process, and may benefit in a similar manner to that described above.

That is, a horizontal orientation is just one example of a predetermined orientation for an image component. It is possible that other orientations and/or other image components may have particular requirements. For example, a vertically aligned barcode could be required for a particular application, or some human readable codes may have particular readability requirements.

In addition to the methods described above, the labelling apparatus may be configured to select an appropriate printing and application orientation so as to ensure that an image component of an image printed on a label has a predetermined orientation when applied to an article. The selection may, for example, be based on a selection (e.g. a user input) of a preferred label orientation (e.g. landscape or portrait). It is not required that the orientation is determined based on data indicative of image quality, or even any other indication of image quality.

It is noted that a 2-axis linear arm is described above. However, alternative label applicators may be used in some applications. For example, any suitable label applicator could be used, provided it can be operated to rotate a label between being printed and being applied. For example, any applicator having a pneumatic or motor driven arm which is arranged to move an applicator head along a primary axis towards and away from a pallet to apply a label to a front face of a pallet may be preferred in some situations where more or less labelling flexibility is required. The applicator head may be configured for rotation between a first labelling orientation and second (rotated) labelling orientation, so as to allow a landscape printed, but portrait dispensed, label to be rotated to be applied in a landscape orientation.

Alternatively, a label applicator apparatus may be configured such that labels are rotated by default. For example, in certain circumstances (e.g. due to space constraints) it may be preferred for a label to be dispensed in a landscape orientation, even where it is intended for labels to be applied in a portrait orientation, with a barcode having been printed in a picket-fence orientation. The applicator head may be configured to rotate portrait printed, but landscape dispensed, labels for application. In such an arrangement, if image quality (e.g. expected or detected) issues are identified, the applicator head may be configured to cease rotating labels, such that landscape printed and dispensed labels are also applied in a landscape orientation.

While embodiments of the present disclosure are described above, it will be appreciated that these are provided by way of example only, and are not intended to be limiting in nature. Indeed, various alternatives and variations to the specific embodiments described herein will be understood to be possible without departing from the scope of the present disclosure. The scope of the invention is defined by the appended claims.

1. A system configured to print and apply labels to articles comprising:
a label printer configured to print an image on a label in a printing orientation;
a label dispenser configured to dispense the printed label;
a label applicator configured to apply the dispensed label to an article in an application orientation; and
a controller configured to determine the printing orientation and the application orientation in dependence upon an indication of image quality associated with a label.

2. The system according to claim 1, wherein the controller is configured to determine the printing orientation and the application orientation such that an image component within the image has a predetermined orientation when applied to the article.

3. A system configured to print and apply labels to articles comprising:
a label printer configured to print an image comprising an image component on a label in a printing orientation, the printing orientation being selected from a first printing orientation and second printing orientation;
a label dispenser configured to dispense the printed label;
a label applicator configured to apply the dispensed label to an article in an application orientation, the application orientation being selected from a first application orientation and a second application orientation; and
a controller configured to determine the printing orientation and the application orientation such that the image component has a predetermined orientation when applied to the article.

4. The system according to claim 3, wherein the controller is configured to determine the printing orientation and the application orientation in dependence upon an indication of image quality associated with a label.

5. The system according to claim 1, where the controller is configured to:
determine data indicative of image quality associated with the label, and
determine the printing orientation and the application orientation in dependence upon the data indicative of image quality.

6. The system according to claim 1, wherein the label applicator is configured to:
adjust the orientation of the label relative to the article by rotating the label about a label orientation axis, the label orientation axis being normal to the plane of the label, and
apply the label to the article in the application orientation.

7. (canceled)

8. The system according to claim 1, wherein the controller is configured to receive an indication of image quality from at least one of:
an image sensor;
a barcode scanner;
a barcode verifier;
a controller associated with the printer, the indication of image quality comprising data indicative of an expected image quality; and
a user input.

9. The system according to claim 1, wherein the system is configured to adjust the orientation of the image to be printed on the label and/or an image component of the image to be printed on the label.

10. (canceled)

11. The system according to claim 1, wherein the image printed on the label comprises a barcode, and wherein the indication of image quality comprises an indication of barcode quality.

12. (canceled)

13. The system according to claim 11, wherein:
when the printing orientation is a first printing orientation, the application orientation is a first application orientation;
when the printing orientation is a second printing orientation, the application orientation is a second application orientation; and
the barcode comprises a plurality of bars, the bars being aligned with a label dispensing direction when the printing orientation is the first printing orientation; and
wherein the bars are orthogonal to the label dispensing direction when the printing orientation is the second printing orientation.

14. (canceled)

15. The system according to claim 1, further comprising a sensor configured to generate sensor data indicative of a characteristic of an image printed on the label.

16. The system according to claim 15, wherein:
when the printing orientation is a first printing orientation, the application orientation is a first application orientation;
when the printing orientation is a second printing orientation, the application orientation is a second application orientation, and
the system is configured to:
print a first label in the first printing orientation;
generate sensor data indicative of the characteristic of the image printed on the first label;
determine data indicative of image quality based on the sensor data; and
if the data indicative of image quality meets a predetermined printed criterion:
determine that the printing orientation is the first printing orientation, and
the application orientation is the first application orientation; and
apply the printed label in the first application orientation.

17. The system according to claim 16, wherein:
if the data indicative of image quality does not meet the predetermined printed criterion, the system is configured to:
discard the first printed label;
print a second label in the second printing orientation;
determine that the printing orientation is the second printing orientation and the application orientation is the second application orientation; and
apply the second printed label in the second application orientation.

18. The system according to claim 1, wherein indication of image quality comprises data indicative of an expected image quality, and the data indicative of an expected image quality is generated based on data indicative of a characteristic of the printer.

19. (canceled)

20. The system according to claim 18, wherein:
if the data indicative of an expected image quality meets a predetermined expected criterion, the system is configured to print a first label in the first printing orientation; and
if the data indicative of an expected image quality does not meet the predetermined expected criterion, the system is configured to print a first label in the second printing orientation.

21. (canceled)

22. The system according to claim 1, further comprising:
a sensor configured to generate sensor data indicative of a characteristic of a label applied to the article;
wherein the system is configured to obtain data indicative of a characteristic of a label applied to the article in either of the first application orientation or the second application orientation.

23. (canceled)

24. The system according to claim 22, wherein:
if the sensor data indicative of a characteristic of a label applied to the article does not meet a predetermined applied criterion, and if the application orientation is the first application orientation, the system is configured to:
print a second printed label in the second printing orientation;
determine that the application orientation is the second application orientation; and
apply the second printed label in the second application orientation.

25. (canceled)

26. The system according to claim 1, wherein the label applicator comprises:
a first actuator configured to move a label towards and away from the article;
a second actuator configured to move the label in a direction parallel with the article movement direction; and
a third actuator configured to rotate the label applicator pad about a vertical axis.

27. A method of applying labels to articles comprising:
determining a printing orientation;
printing an image on a label in the printing orientation;
dispensing the printed label;
determining an application orientation; and
applying the label to an article in the application orientation;
wherein the printing orientation and the application orientation are determined in dependence upon an indication of image quality associated with a label.

28-29. (canceled)

30. The method according to claim 27, further comprising:
determining data indicative of image quality associated with the label, and
determining the printing orientation and the application orientation in dependence upon the data indicative of image quality.

31. The method of claim 27, wherein:
when the printing orientation is a first printing orientation, the application orientation is a first application orientation; and
when the printing orientation is a second printing orientation, the application orientation is a second application orientation;
the method comprising:
printing a first label in the first printing orientation;
generating sensor data indicative of a characteristic of an image printed on the first label;
determining data indicative of image quality based on the sensor data; and
if the data indicative of image quality meets a predetermined printed criterion:
determining that the printing orientation is the first printing orientation and the application orientation is the first application orientation; and
applying the printed label in the first application orientation.

32. The method of claim 31, comprising:
if the data indicative of image quality does not meet the predetermined printed criterion:
discarding the first printed label;
printing a second label in the second printing orientation;
determining that the printing orientation is the second printing orientation and the application orientation is the second application orientation; and
applying the second printed label in the second application orientation.
